(19) United States
(12) Patent Application Publication
(10) Pub. No.: US 2020/0302373 A1
(43) Pub. Date: Sep. 24, 2020

(54) INFORMATION PROCESSING APPARATUS AND NON-TRANSITORY COMPUTER READABLE MEDIUM STORING PROGRAM

(71) Applicant: FUJI XEROX CO., LTD., TOKYO (JP)

(72) Inventors: Tadao MICHIMURA, Kanagawa (JP); Norio YAMAMOTO, Kanagawa (JP); Naoyuki ENOMOTO, Kanagawa (JP); Shinya NAKAMURA, Kanagawa (JP); Jun ANDO, Kanagawa (JP)

(73) Assignee: FUJI XEROX CO., LTD., TOKYO (JP)

(21) Appl. No.: 16/521,571

(22) Filed: Jul. 24, 2019

(30) Foreign Application Priority Data
Mar. 19, 2019 (JP) 2019-050814

(51) Int. Cl. G06Q 10/06; G06K 9/62

(52) U.S. Cl. CPC G06Q 10/063118; G06Q 10/063114; G06K 9/6218

(57) ABSTRACT

An information processing apparatus includes a generation unit that generates plural candidates having different relationships of allocation to plural groups in a case where a relationship in which all prospective participants are allocated to the plural groups is set as a single candidate, a calculation unit that calculates the extent of being similar to plural groups used in each execution of the past group activity for each execution of group activity with respect to each of the plural generated candidates, and a determination unit that determines a candidate used in the present group activity from among the plural generated candidates except a candidate having the highest extent of being similar to each execution of group activity.

### CROSS-REFERENCE TO RELATED APPLICATIONS

This application is based on and claims priority under 35 USC 119 from Japanese Patent Application No. 2019-050814 filed Mar. 19, 2019.

### BACKGROUND

### (i) Technical Field

The present invention relates to an information processing apparatus and a non-transitory computer readable medium storing a program.

### (ii) Related Art

In recent years, it has been required to acquire and develop the ability for playing an active role in a group while respecting diversity. One method is adoption of group learning in which a solution to a problem with no clear answer is discussed with various members. In the group learning, members gathered on an ad hoc basis have discussions based on their knowledges or experiences.

JP2012-098921A is an example of the related art.

### SUMMARY

A result in group learning is influenced by attributes or characteristics of members constituting a group. Thus, it is preferable that a group is constituted such that attributes or characteristics of members are not biased. For example, in a method of classifying members into groups by focusing on differences in attributes or characteristics of the members, a group having a member constitution similar to a member constitution in the past group learning is frequently generated.

Aspects of non-limiting embodiments of the present disclosure relate to an information processing apparatus and a non-transitory computer readable medium storing a program, capable of improving an activity result in a constituted new group compared with a case where the extent of being similar between a candidate of the constituted new group and a group constituted in the past is not taken into consideration.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a generation unit that generates a plurality of candidates having different relationships of allocation to a plurality of groups in a case where a relationship in which all prospective participants are allocated to the plurality of groups is set as a single candidate; a calculation unit that calculates the extent of being similar to a plurality of groups used in each execution of the past group activity for each execution of group activity with respect to each of the plurality of generated candidates; and a determination unit that determines a candidate used in the present group activity from among the plurality of generated candidates except a candidate having the highest extent of being similar to each execution of group activity.

### BRIEF DESCRIPTION OF THE DRAWINGS

Exemplary embodiment(s) of the present invention will be described in detail based on the following figures, wherein:

FIG. 1 is a diagram for describing a conceptual configuration of an information processing system according to an exemplary embodiment;

FIG. 2 is a diagram for describing a configuration example of each of a client terminal, a management server, and group generation apparatus;

FIG. 3 is a diagram for describing an example of a functional configuration of a control unit configuring the group generation apparatus according to the exemplary embodiment;

FIG. 4 is a flowchart diagram for describing a process operation executed by the group generation apparatus according to the exemplary embodiment;

FIG. 5 is a diagram for describing an example of a process executed up to step 3;

FIG. 6 is a diagram for describing an example of a similarity calculated in step 5;

FIG. 7 is a diagram for describing an example of the minimum value of a similarity of each candidate extracted in step 6; and

FIG. 8 is a diagram for describing an example of a candidate detected in step 7.

### DETAILED DESCRIPTION

Hereinafter, with reference to the drawings, an exemplary embodiment of the present invention will be described.

### EXEMPLARY EMBODIMENT

Overall Configuration of System

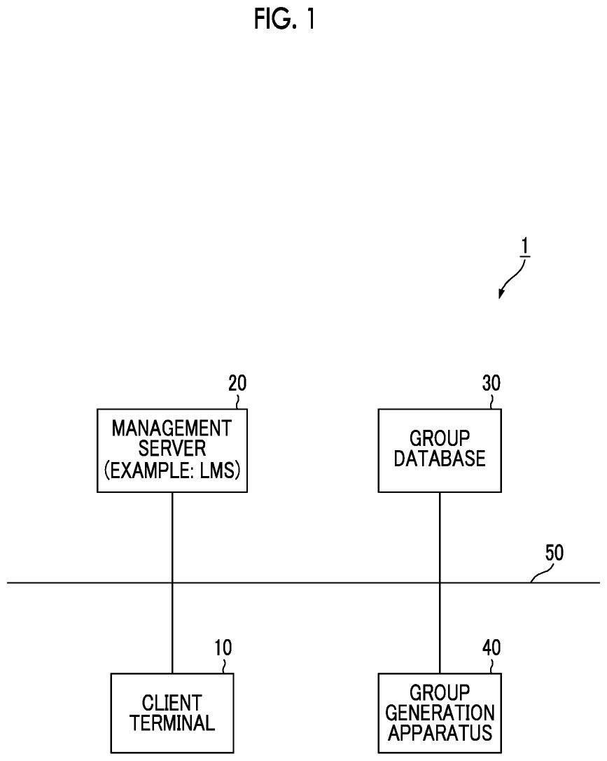

FIG. 1 is a diagram for describing a conceptual configuration of an information processing system 1 according to an exemplary embodiment. The information processing system 1 illustrated in FIG. 1 is supposed to be used in education institutes. Thus, the information processing system 1 includes a client terminal 10 operated by a teacher or the like, a management server 20 managing management data, a group database 30 recording information regarding a group used in past executions, and a group generation apparatus 40 generating a group used for group learning. The client terminal 10, the management server 20, the group database 30, and the group generation apparatus 40 are connected to each other via a network 50. The group learning here is a form of group activity in which a plurality of people discuss a given theme.

The client terminal 10 in the present exemplary embodiment includes not only a terminal operated by a teacher but also a terminal operated by a student. The client terminal 10 is a computer that can be connected to the network. The computer may be a stationary computer, and may be a portable computer. As the portable computer, for example, a notebook computer, a tablet computer, or a smart phone may be used. The teacher operates the client terminal 10, and thus instructs the group generation apparatus 40 to generate a group used for the present group learning.

The management server 20 in the present exemplary embodiment is a server used as, for example, a learning management system (LMS), an academic affairs system, or a book system. In a case where the management server 20 is the LMS, history and a result of learning, a record of attendance, a record of submission of homework, and the like are managed as management data. In a case where the management server 20 is the academic affairs system, a record of a course, a grade, a school year, faculty, department, and major are managed as management data. In a case where the management server 20 is the book system, a book lending record and a book reading record are managed as management data.

For example, a single management server 20 is not limited to the above-described specific system. For example, the single management server 20 may operate as the plurality of systems. The information recorded in the management server 20 may be viewed from either a terminal operated by a teacher or a terminal operated by a student. For example, grades of students managed in the management server 20 may be viewed, or learning materials may be uploaded to the management server 20, from the terminal operated by the teacher. The learning materials managed in the management server 20 or a grade of the student may be viewed from the terminal operated by the student.

The group database 30 is a nonvolatile storage device recording a member constitution of a group used in past executions of group learning (hereinafter, also referred to as the “past executions”). For example, a hard disk drive (HDD) may be used as the nonvolatile storage device. In a case of the present exemplary embodiment, the group database 30 is a standalone device, but may be a part of the management server 20 or the group generation apparatus 40. The group generation apparatus 40 is a computer generating a member constitution of a group used in the present group learning in cooperation with the management server 20 or the group database 30.

In a case where a relationship in which all members are allocated to any one of a plurality of groups is set as a single candidate, the group generation apparatus 40 of the present exemplary embodiment detects a candidate having a low extent of being similar to a plurality of groups used in each past execution among a plurality of candidates having different allocation relationships, and outputs the candidate as groups used in the present group learning. Here, the group generation apparatus 40 is an example of an information processing apparatus. The network 50 is, for example, the Internet or a local area network (LAN). The network 50 may be a wired network, and may be a wireless network.

Configuration of Each Apparatus

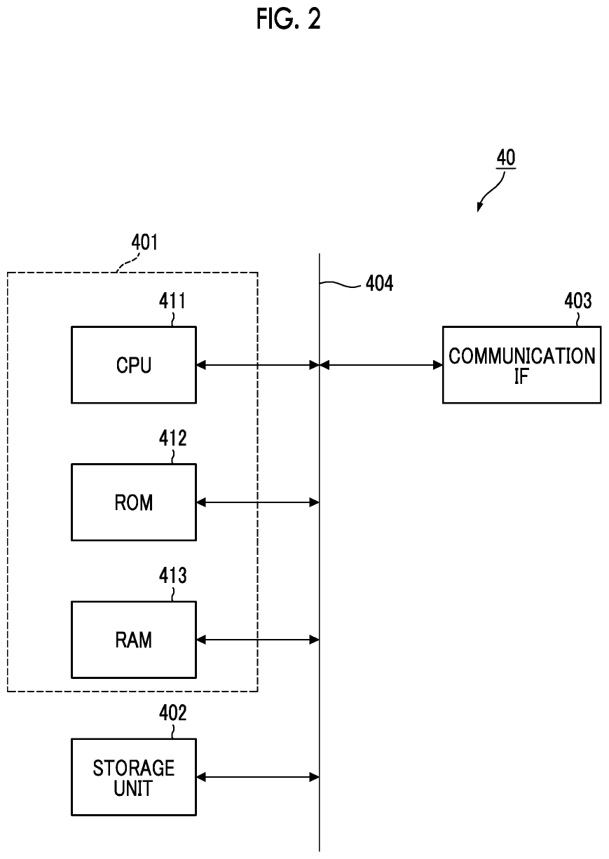

FIG. 2 is a diagram for describing a configuration example of each of the client terminal 10 (refer to FIG. 1), the management server 20 (refer to FIG. 1), and the group generation apparatus 40. As described above, the client terminal 10, the management server 20, and the group generation apparatus 40 all have a configuration based on a computer. In FIG. 2, as a representative example, the group generation apparatus 40 will be described.

The group generation apparatus 40 includes a control unit 401 that controls the overall operation of the apparatus, a storage unit 402 that stores an application program (hereinafter, referred to as a “program”) or the like, and a communication interface (communication IF) 403 that performs communication using a LAN cable or the like. The control unit 401 includes a central processing unit (CPU) 411, a read only memory (ROM) 412 storing firmware or a basic input output system (BIOS), and a random access memory (RAM) 413 used as a work area. The CPU 411 may be a multicore. The ROM 412 may be a rewritable nonvolatile semiconductor memory.

The storage unit 402 is a nonvolatile storage device, and is configured with, for example, a hard disk drive (HDD) or a semiconductor memory. The storage unit 402 stores data used to generate a member constitution of a group used for group learning. The control unit 401 and each unit are connected to each other via a bus 404 or a signal line (not illustrated). The management server 20 of the present exemplary embodiment has the same configuration as that of the group generation apparatus 40.

The client terminal 10 is additionally provided with a display unit displaying a work screen or the like, and an operation reception unit receiving a user's operation. The display unit here is configured with, for example, a liquid crystal display or an organic EL display. The display unit may be integrated with a main body of the client terminal 10, and may be connected to the main body of the client terminal 10 as a standalone device. The operation reception unit includes a keyboard used to input text, a mouse used to move a pointer on a screen or to input selection, and a touch sensor. In a case of the present exemplary embodiment, an operation on the group generation apparatus 40 is input by using the display unit and the operation reception unit of the client terminal 10.

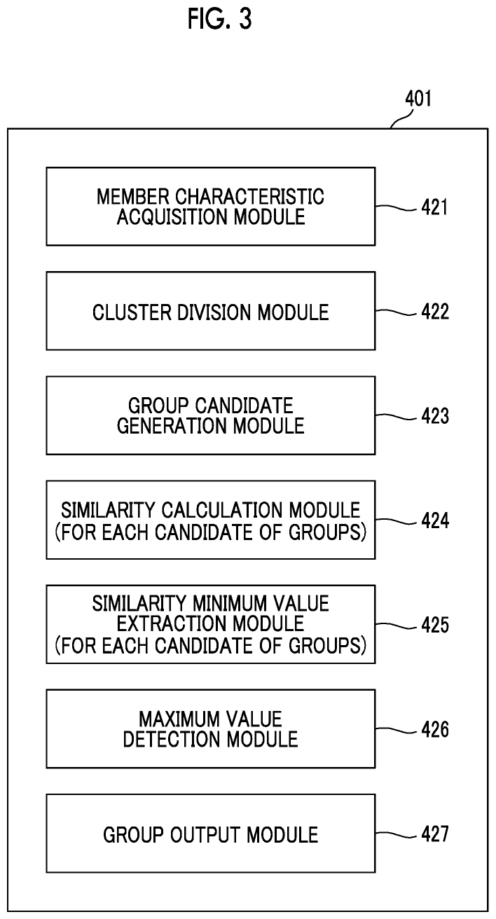

FIG. 3 is a diagram for describing an example of a functional configuration of the control unit 401 configuring the group generation apparatus 40 according to the exemplary embodiment. Modules illustrated in FIG. 3 are realized by the CPU 411 (refer to FIG. 2) executing programs. The modules illustrated in FIG. 3 are parts of the program executed by the control unit 401.

One of the modules illustrated in FIG. 3 is a member characteristic acquisition module 421 that acquires a grade or a characteristic (hereinafter, referred to as a “grade” or the like) of a member who participates in group learning. The member here is an example of a prospective participant. In a case of the present exemplary embodiment, members participating in group learning are the same as each other every time. In other words, the group learning is executed for the same members a plurality of times. The term “same members” here indicates that the same members on a nominal list. For example, even though some or all members participating in the group learning differ, this does not hinder an operation of the group generation apparatus 40. The member characteristic acquisition module 421 acquires characteristics or the like of members from the management server 20 (refer to FIG. 1).

One of the modules illustrated in FIG. 3 is a cluster division module 422 that divides members participating in group learning into a plurality of clusters based on similarity of acquired characteristics or the like. A method of members into clusters includes, for example, a hierarchy cluster analysis method and a non-hierarchy cluster analysis method. A division process in the cluster division module 422 is not required to be executed every time group learning is executed. For example, in a case where the number of days elapsed from the previous group learning is small, a member constitution allocated to each cluster may be highly possibly the same as that in the previous group learning. On the other hand, in a case where the number of days from group learning of a plurality of times before is large, a member constitution allocated to each cluster may be changed. Thus, it may be determined whether or not division in the cluster division module 422 is to be executed based on, for example, the number of times of group learning or a time elapsed from the previous division. A teacher may give an instruction for whether or not members are divided into clusters.

One of the modules illustrated in FIG. 3 is a group candidate generation module 423 that extracts one member from each cluster, allocates the member to a single group, and generates a plurality of candidates of allocation of the members to a plurality of groups. In a case of the present exemplary embodiment, the group candidate generation module 423 generates three candidates. The number of groups constituting a single candidate is set in advance. In a case of the present exemplary embodiment, a single candidate includes five groups. In other words, group learning is executed in the five groups. In a case of the present exemplary embodiment, the number of members of each group is identical. For example, six members are allocated to a single group. For example, in a case where a total number of members is indivisible by the number of groups, the number of members constituting each group is not identical.

In a case of the present exemplary embodiment, among members constituting each group, the number of members belonging to an identical cluster is allocated to be as uniform as possible. For example, one member is allocated to each group from each cluster. In other words, a cluster bias among members constituting each group is reduced. Since the cluster bias among members is reduced, the homogeneity among the members is reduced, and thus multifaceted discussions are expected. For example, in a case where the number of members among clusters is not uniform, a plurality of members may be allocated to a single group from an identical cluster. In a plurality of candidates generated by the group candidate generation module 423, two or more groups having different member constitutions are present between compared candidates. The group candidate generation module 423 is an example of a generation unit.

One of the modules illustrated in FIG. 3 is a similarity calculation module 424 that calculates, for each candidate of groups, the extent (hereinafter, also referred to as a “similarity”) to which a member constitution is similar between a candidate of groups and groups used in past executions. In a case where past executions are three, three similarities are calculated for a single candidate. In a case of the present exemplary embodiment, the number of candidates is three, and thus a total of nine similarities are calculated. In a case of the present exemplary embodiment, the similarity indicates a distance between sets of groups. Thus, a value of the similarity is reduced as the extent of being similar becomes higher, and a value of the similarity is increased as the extent of being similar becomes lower.

In a case of the present exemplary embodiment, the similarity is computed according to the following equation.

Similarity=(1−cosine similarity)/2

The cosine similarity is a value indicating the closeness of an angle formed between n-dimensional vectors, takes the maximum value “1” in a case where directions of the vectors match each other, takes “0” in a case where the directions are orthogonal to each other, and takes the minimum value “−1” in a case where the directions are reverse to each other. The equation is used to convert the cosine similarity into a distance. In the equation, the similarity is divided by 2 such that the maximum value of the similarity is normalized to “1”. In a case of the present exemplary embodiment, one of two vectors is a set of groups used in the past group learning, and the other is a set of groups generated as a candidate. An element of the vector corresponding to the set of groups used in the past is a member of each group. On the other hand, an element of the vector corresponding to the candidate is a member of each group constituting the candidate.

The similarity may be calculated by using others than the cosine similarity. For example, a Pearson's correlation coefficient may be used. In a case of the Pearson's correlation coefficient, a similarity corresponding to a distance may also be calculated by using the above equation. The following equation may be used as a conversion formula for computing a similarity corresponding to a distance by using a cosine similarity. Similarity=exp(−cosine similarity)

The similarity calculation module 424 here is an example of a calculation unit.

One of the modules illustrated in FIG. 3 is a similarity minimum value extraction module 425 that extracts the smallest value (hereinafter, referred to as the “minimum value”) of calculated a similarity for each candidate of groups. In a case of the present exemplary embodiment, the number of candidates of groups is three, and thus three minimum values are extracted. Here, for each candidate, a case where the extent of being similar to groups used in past executions is highest is extracted.

One the modules illustrated in FIG. 3 is a maximum value detection module 426 that detects the maximum value among extracted minimum values of the similarity. In a case of the present exemplary embodiment, the maximum value among minimum values indicates that the extent of being similar is lowest among the three candidates. Through this process, a candidate for which the extent of being similar is relatively low with respect to any one of groups used in past executions is determined. The similarity minimum value extraction module 425 and the maximum value detection module 426 are an example of determination unit. One of the modules illustrated in FIG. 3 is a group output module 427 that outputs information regarding a determined candidate of groups. For example, a teacher or a student is notified of a member constitution of each group corresponding to the candidate.

Example of Process Operation

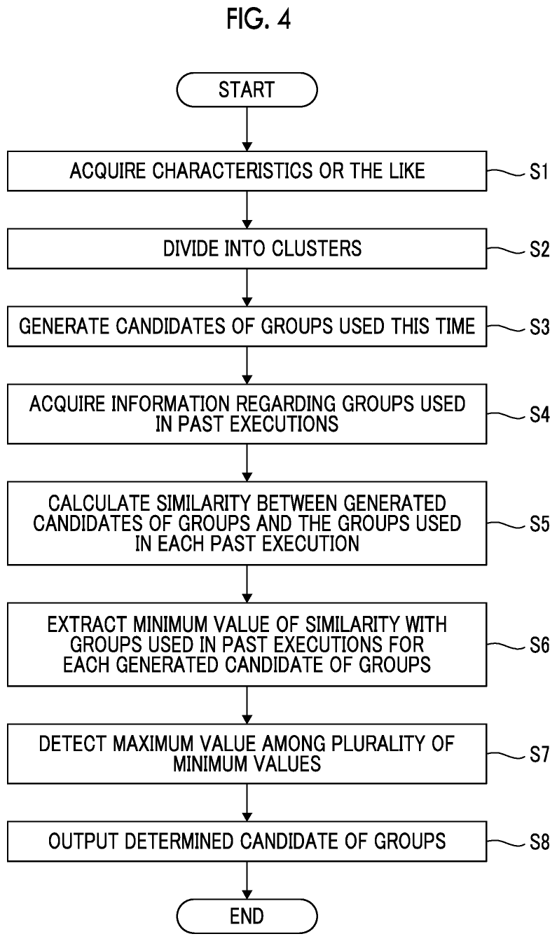

Hereinafter, a description will be made of a process operation in Exemplary Embodiment 1. FIG. 4 is a flowchart for describing a process operation executed by the group generation apparatus 40 (refer to FIG. 1) according to the exemplary embodiment. The reference sign S in the flowchart indicates a step. First, the group generation apparatus 40 acquires characteristics or the like of members participating in group learning (step 1). The characteristics or the like are acquired from the management server 20 (refer to FIG. 1). In a case of the present exemplary embodiment, the number of members is thirty. Next, the group generation apparatus 40 divides the members into clusters (step 2). For example, the thirty members are allocated to five clusters by six people.

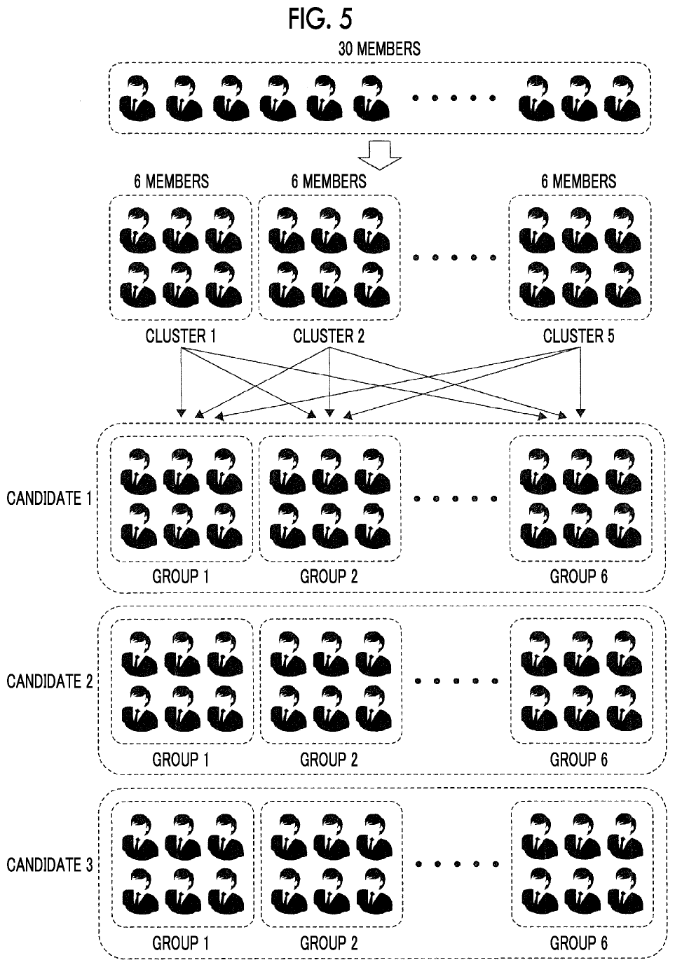

Next, the group generation apparatus 40 generates candidates of groups used this time (step 3). A single candidate is generated by allocating all the members to any one of six groups. The group generation apparatus 40 in the present exemplary embodiment performs the generation three times, and thus generates three candidates. FIG. 5 is a diagram for describing an example of a process executed up to step 3. In FIG. 5, a total number of members is thirty, and the members are divided into five clusters by six people. As described above, the number of people of each cluster may not be identical. In the example illustrated in FIG. 5, the number of people of each cluster is six. The number of groups is six. Thus, in the example illustrated in FIG. 5, one person of each cluster is allocated to a single group. In FIG. 5, three candidates differing in member allocation will be respectively referred to as a “candidate 1”, a “candidate 2”, and a “candidate 3”.

FIG. 4 will be referred to again. Next, the group generation apparatus 40 acquires information regarding groups used in past executions (step 4). Specifically, information regarding a member constitution of a used group is acquired for each past execution. In a case where there is no history of group learning executed in the past, anyone of the generated candidates is used as groups used this time. In this case, processes from step 4 to step 7 which will be described later are skipped. Next, the group generation apparatus 40 calculates a similarity between the generated candidates of groups and the groups used in each past execution (step 5). In a case of the present exemplary embodiment, nine similarities are calculated between three candidates and groups corresponding to three executions.

Next, the group generation apparatus 40 extracts the minimum value of a similarity with the groups used in the past executions for each generated candidate of groups (step 6). Next, the group generation apparatus 40 detects the maximum value among a plurality of minimum values (step 7). This process indicates that a candidate in which the extent of being similar to the groups used in the past executions is relatively low is selected. Thereafter, the group generation apparatus 40 outputs the determined candidate of groups (step 8). Member constitutions of the groups determined to be used in the present group learning are output to the client terminal 10 (refer to FIG. 1) operated by a teacher or a student, and are also stored in the group database 30.

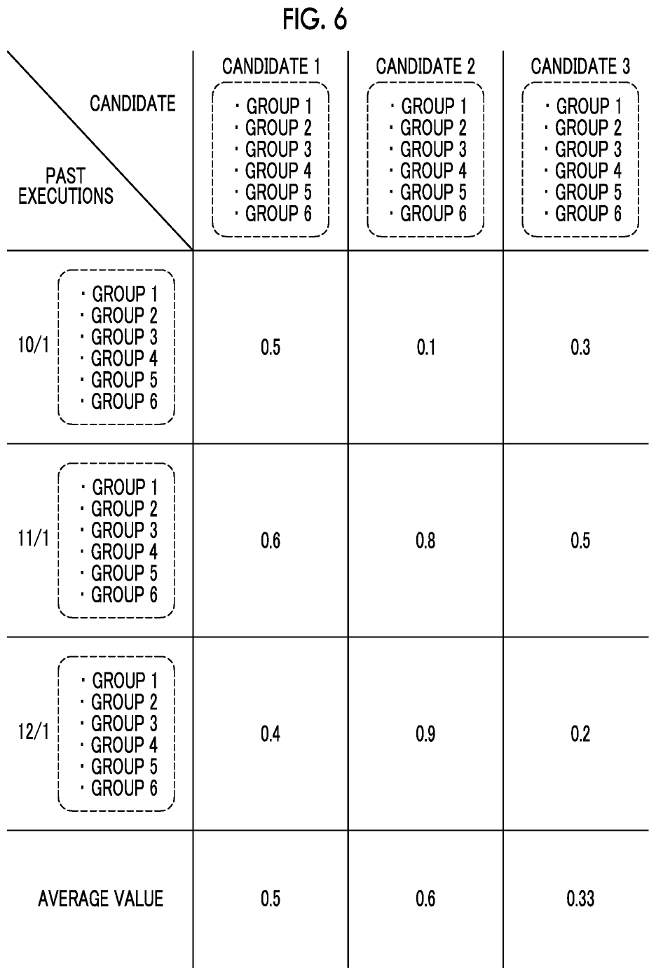

Hereinafter, with reference to FIGS. 6 to 8, a description will be made of a process of determining a candidate of groups. FIG. 6 is a diagram for describing an example of a similarity calculated in step 5. In FIG. 6, a transverse axis expresses three candidates generated in step 3, and a longitudinal axis expresses groups used in past executions. In FIG. 6, group learning is executed on October 1, November 1, and December 1. Numerical values in FIG. 6 indicate calculated similarities. For example, in a case of the candidate 1, the similarity with the groups used on October 1 is “0.5”, the similarity with the groups used on November 1 is “0.6”, and the similarity with the groups used on December 1 is “0.4”.

For example, in a case of the candidate 2, the similarity with the groups used on October 1 is “0.1”, the similarity with the groups used on November 1 is “0.8”, and the similarity with the groups used on December 1 is “0.9”. For example, in a case of the candidate 3, the similarity with the groups used on October 1 is “0.3”, the similarity with the groups used on November 1 is “0.5”, and the similarity with the groups used on December 1 is “0.2”. FIG. 6 also illustrates average values of the similarities. In terms of three average values, the groups of the candidate 2 has the lowest extent of being similar with respect to the past executions.

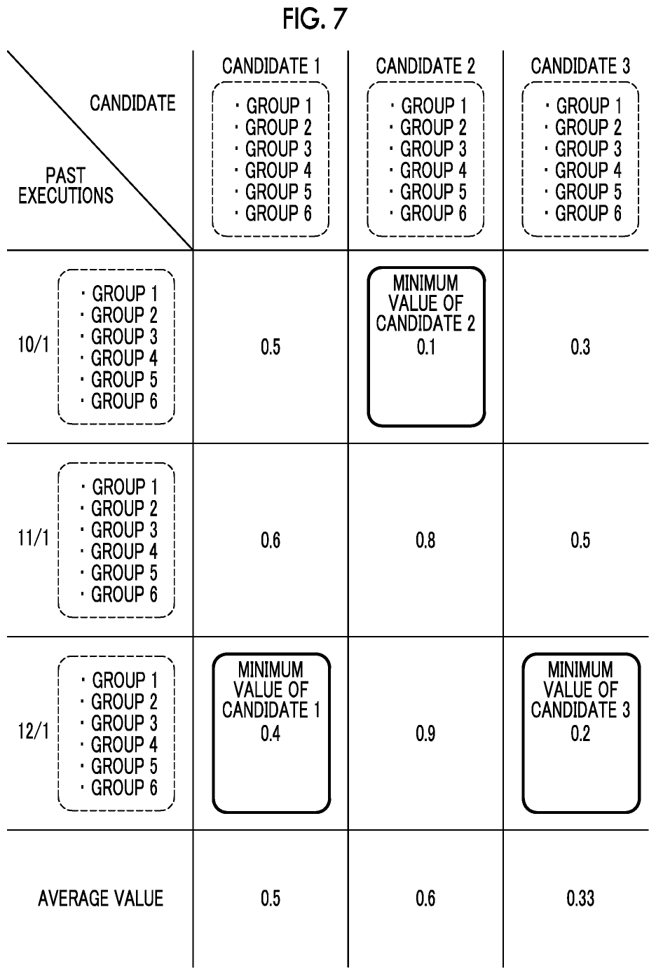

FIG. 7 is a diagram for describing illustrating an example of the minimum value of a similarity of each candidate extracted in step 6. In FIG. 7, a portion corresponding to FIG. 6 is illustrated to be given a corresponding reference numeral. In FIG. 7, the minimum value of similarities of each candidate is illustrated to be surrounded by a thick frame. In a case of the candidate 1, the similarity with the group used on December 1 is the minimum. Therefore, the extent of the groups of the candidate 1 being similar to the groups used in other executions is lower. In a case of the candidate 2, the similarity with the groups used on October 1 is the minimum. Therefore, the extent of the groups of the candidate 2 being similar to the groups used in other executions is lower. In a case of the candidate 3, the similarity with the group used on December 1 is the minimum. Therefore, the extent of the groups of the candidate 3 being similar to the groups used in other executions is lower.

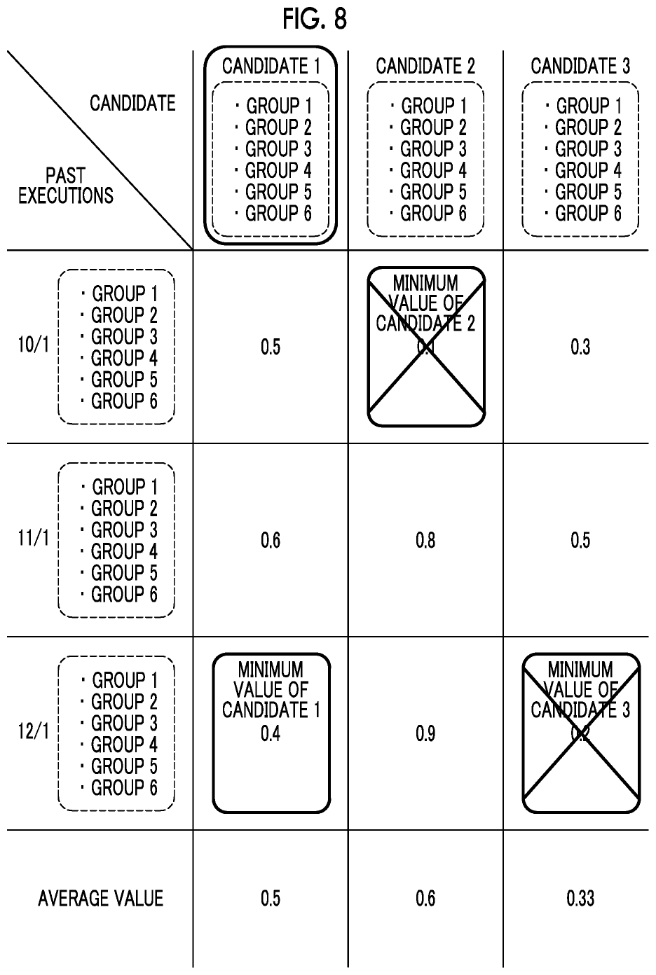

FIG. 8 is a diagram for describing a candidate detected in step 7. In FIG. 8, a portion corresponding to FIG. 7 is illustrated to be given a corresponding reference numeral. In the example illustrated in FIG. 8, the minimum value of the candidate 1 is detected as the maximum value among the minimum values corresponding to the respective candidates. Thus, in a case of the present exemplary embodiment, member constitutions of the groups corresponding to the candidate 1 are used in the present group learning. As in the present exemplary embodiment, a similarity with groups used in each execution is calculated, the minimum value in each candidate is extracted, the maximum value of minimum values among candidates is detected, and thus it is possible to more reliably select a candidate with a low extent of being similar than in a case of focusing only an average value. For example, in FIG. 8, in a case where only an average value is focused, the candidate 2 with the highest extent of being similar to the past groups is selected among the three candidates, but, in a case of the present exemplary embodiment, the candidate 2 is excluded.

### OTHER EXEMPLARY EMBODIMENTS

As mentioned above, the exemplary embodiment of the present invention has been described, but the technical scope of the present invention is not limited to the scope disclosed in the exemplary embodiment. It is clear from the disclosure of the claims that exemplary embodiments obtained by adding various changes or alterations to the exemplary embodiment are included in the technical scope of the present invention.

In the exemplary embodiment, groups used in group learning are generated by using the group generation apparatus 40 (refer to FIG. 1), but groups used in group work in a company may be generated. In a case of the exemplary embodiment, the group generation apparatus 40 is handled as an apparatus independent from the client terminal 10 (refer to FIG. 1) or the management server 20 (refer to FIG. 1), but the function of the group generation apparatus 40 may be executed as a part of the function of the client terminal 10 or the like. The group generation apparatus 40 may be realized as a cloud server or an on-premise server.

In a case of the exemplary embodiment, in step 7 (step 4), the candidate 1 corresponding to the maximum value of minimum values of similarities with past executions, extracted for each candidate, is determined as a candidate used in the present group learning, but candidates other than a candidate corresponding to a minimum value of minimum values corresponding to the respective candidates may be determined as candidates used in the present group learning. For example, in the example illustrated in FIG. 8, among the minimum values corresponding to the three candidates, the candidate 3 corresponding to the second smallest minimum value may be determined as a candidate used in the present group learning. Also in this case, improvement in a learning effect is expected more than in a case where the candidate 2 is selected.

In a case of the present exemplary embodiment, in step 7 (refer to FIG. 4), a description has been made assuming that a single maximum value of minimum values corresponding to respective candidates is found, but, in a case where a plurality of identical maximum values are found, with respect to candidates in which the maximum values are found, maximum values of similarities are extracted, and a candidate including a greater maximum value is selected. In a case where a maximum value of a similarity is focused, and a plurality of identical maximum values are found, one of corresponding candidates is selected.

In the exemplary embodiment, the value of the similarity calculated in step 5 (refer to FIG. 4) is used without being changed, but a value obtained by multiplying the value by a correction corresponding to corresponding to an execution may be used in step 6 and 7. For example, as an execution becomes older, a correction coefficient may be increased. In this case, even though similarities calculated in step 5 are the same as each other in the latest execution and the oldest execution, the past similarity is corrected to a greater value. In other words, a correction coefficient is given to reduce the extent of being similar more than before correction. This indicates that the influence of groups used in an old execution on groups used in the previous execution is reduced. A value after correction is made not to exceed a preset value. In a case of the present exemplary embodiment, the value after correction is made not to exceed “1”. The correction coefficient may be defined according to elapsed time until the current time. Also in this case, as elapsed time becomes longer, a correction coefficient is given to reduce the extent of being similar more than before correction.

In the exemplary embodiment, a description has been made of an example in which a similarity corresponding to a distance is computed by using a cosine similarity, but other computation methods may be used. For example, a Euclid distance may be used as the similarity.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a generation unit that generates a plurality of candidates having different relationships of allocation to a plurality of groups in a case where a relationship in which all prospective participants are allocated to any one of the plurality of groups is set as a single candidate;
a calculation unit that calculates the extent of being similar to a plurality of groups used in each execution of the past group activity for each execution of group activity with respect to each of the plurality of generated candidates; and
a determination unit that determines a candidate used in the present group activity from among the plurality of generated candidates except a candidate having the highest extent of being similar to each execution of group activity.

2. The information processing apparatus according to claim 1,
wherein the determination unit specifies a plurality of values of the highest extent of being similar to a plurality of groups used in each execution of the past group activity with respect to the plurality of respective candidates, and excludes a candidate corresponding to the greatest value among the plurality of specified values of the highest extent of being similar from a candidate target used in the present group activity.

3. The information processing apparatus according to claim 2,
wherein the determination unit determines a candidate corresponding to the smallest value among the plurality of specified values of the highest extent of being similar, as a candidate used in the present group activity.

4. The information processing apparatus according to claim 1,
wherein the extent of being similar calculated by the calculation unit is multiplied by a correction coefficient corresponding to an execution, or elapsed time until the current time.

5. The information processing apparatus according to claim 4,
wherein the correction coefficient is given to reduce the extent of being similar more than before correction, as an execution becomes older or elapsed time until the current time becomes longer.

6. A non-transitory computer readable medium storing a program causing a computer to execute:
a function of generating a plurality of candidates having different relationships of allocation to a plurality of groups in a case where a relationship in which all prospective participants are allocated to any one of the plurality of groups is set as a single candidate;
a function of calculating the extent of being similar to a plurality of groups used in each execution of the past group activity for each execution of group activity with respect to each of the plurality of generated candidates; and
a function of determining a candidate used in the present group activity from among the plurality of generated candidates except a candidate having the highest extent of being similar to each execution of group activity.

7. An information processing apparatus comprising:
generation means for generating a plurality of candidates having different relationships of allocation to a plurality of groups in a case where a relationship in which all prospective participants are allocated to any one of the plurality of groups is set as a single candidate;
calculation means for calculating the extent of being similar to a plurality of groups used in each execution of the past group activity for each execution of group activity with respect to each of the plurality of generated candidates; and
determination means for determining a candidate used in the present group activity from among the plurality of generated candidates except a candidate having the highest extent of being similar to each execution of group activity.
